(19) United States
(12) Patent Application Publication
(10) Pub. No.: US 2006/0014126 A1
(43) Pub. Date: Jan. 19, 2006

(54) System for tutoring users of a medical apparatus on the operation of that medical apparatus

(75) Inventors: Michael Esposito, Carmel, IN (US); Richard E. Galloway, Chicago, IL (US)

Correspondence Address: McDonnell Boehnen Hulbert & Berghoff, 32nd Floor, 300 S. Wacker Drive, Chicago, IL, 60606, US

(73) Assignee: Healing Solutions, LLC

(21) Appl. No.: 11/152,355

(22) Filed: Jun. 14, 2005

Related U.S. Application Data
(63) Continuation of application No. 10/867,961, filed on Jun. 15, 2004.

(51) Int. Cl. G09B 23/28

(52) U.S. Cl. 434/262

(57) ABSTRACT

A system for providing instantaneous tutoring to a user of a medical apparatus how to operate the medical apparatus. The system includes the medical apparatus in combination with a tutorial component that provides instructions on use and operation of the medical apparatus. The system further includes an input instrument that a user activates to start receiving instructions. When the user has activated the input instrument, the instrument sends a signal to a processing agent which activates the instructions stored in data storage and causes the instructions to be broadcast through an output instrument.

### FIELD OF THE INVENTION

The present invention relates to medical equipment and, more particularly, to a tutorial system that comprises a combination of a medical apparatus and a tutorial component for operating the apparatus.

### BACKGROUND

Medical equipment ranges from simple to extremely complicated. Additionally, medical equipment is also used in a variety of environments, such as hospitals, nursing homes, and even a patient's personal home. With all the ranges in the complexity of medical equipment and environments that the equipment may be used, there is one common factor, that whoever uses the equipment must be educated on the proper operation of the equipment. Regardless of whether the complexity of the equipment, from complicated equipment such as ventilators, surgical equipment, or radiological equipment, to simpler equipment, such as, Continuous Positive Airway Pressure machines, portable oxygen tanks, or therapeutic mattresses such as low-air loss mattresses, or the skill level of the person using the equipment, from a doctor to a layperson assisting a patient at home, any persons operating medical equipment needs adequate training on the features of that specific equipment.

Most medical facilities operate around the clock, with the facility's personnel scheduled in multiple shifts throughout the day. The vendor of the medical equipment is often responsible for the initial training of the facility's personnel on the proper operation of the equipment. This training is often done at the time of installation. Since the vendor of the medical equipment often cannot be present at the medical facility for each shift, only those personnel who are able to be present at the time of installation are trained directly by the vendors. Adding to this training problem is the fact that certain shifts and certain medical facilities experience a high turnover in personnel and/or utilize temporary employees. Thus, a large amount of the training of personnel on these many types of medical equipment is dependant upon information being passed from the personnel on one shift to the personnel on another shift.

Training personnel on the proper operation of medical equipment is imperative and all personnel are at some point must be trained, either by the vendor companies or by their colleagues or superiors. In fact, medical equipment operation training is so important that most, if not all, state governments and medical bodies require training of everyone who is involved in operating medical equipment within the facility. Most states conduct compliance audits to ensure that everyone operating medical equipment in the facility is properly educated on the use of that equipment. Typically, the state will ask a facility to explain how the personnel were initially educated and the procedures for continuing education as well as new-hire education. Failure to pass these audits can have great economic impact on the medical facility, not only in potential fines imposed by the state, but also in the facilities insurance ratings and credibility in the community.

In addition to the medical personnel operating medical equipment, the patients themselves or a non-licensed person administering care to the patient may also operate the medical equipment. In these situations, the person operating the equipment is often trained informally by medical personnel, who were previously trained by the product manufacturer. With each step away from the original equipment manufacturer, it becomes more likely that details in the use of the equipment are missed or inaccurately explained.

Improper use of medical equipment may also result in damage to the equipment being, thereby making it necessary for a medical facility to replace medical equipment more often than it may have had to otherwise. Most medical facilities are on conservative spending budgets and it is financially draining to replace equipment that was damaged by the patients or the staff due to misuse or improper instruction.

But the most severe consequence in this lack of training on the proper use of medical equipment is the potential injury to a patient. Situations where the medical equipment malfunctions or the caregiver uses the equipment incorrectly require immediate attention.

Accordingly, it would be desirable to have a tutorial system that provides users of medical equipment with immediate and on the spot instructions on how to use the medical equipment. It would further be desirable to have a combination of a medical apparatus and a tutorial system that educates a user how to operate that particular apparatus.

### SUMMARY

The present invention is directed to a system for providing instantaneous tutoring to a user of a medical apparatus how to operate the medical apparatus. The system includes the medical apparatus in combination with a tutorial component that provides instructions on use and operation of the medical apparatus. The system further includes an input instrument that a user activates to start receiving instructions. When the user has activated the input instrument, the instrument sends a signal to a processing agent which activates the instructions stored in data storage and causes the instructions to be broadcast through an output instrument.

### BRIEF DESCRIPTION OF THE FIGURES

FIG. 1 is a simplified diagram of a tutorial system according to the present invention.

FIG. 2 is a simplified block diagram illustrating one exemplary embodiment of the external features of a tutorial component of a tutorial system according to the present invention.

FIG. 3 is a simplified block diagram illustrating one exemplary embodiment of the internal elements of a tutorial component according to the present invention.

FIG. 4 is a flow chart illustrating one example of a cycle of operation of a tutorial system in accordance with the exemplary embodiment.

FIG. 5 is a flow chart illustrating an alternative cycle of operation of a tutorial system in accordance with the exemplary embodiment.

### DETAILED DESCRIPTION OF EXEMPLARY EMBODIMENTS

The present invention describes a tutorial system that allows a user of a medical apparatus to receive instantaneous instruction on the use and operation of that medical apparatus.

Exemplary Tutorial System

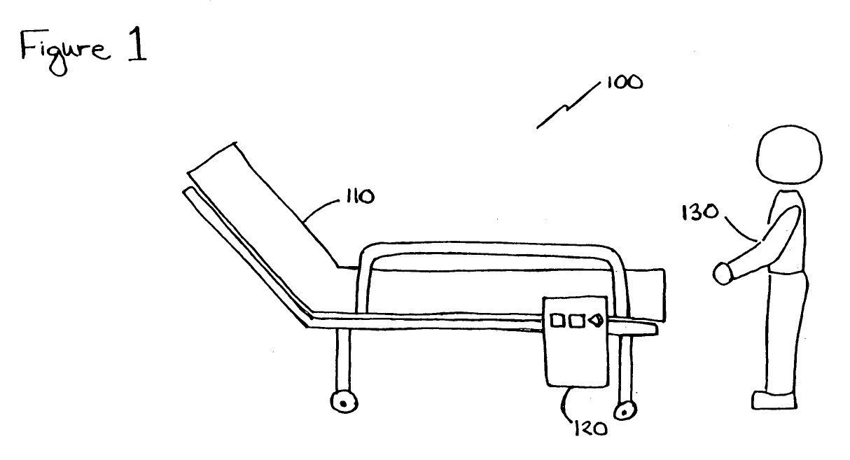

As illustrated in FIG. 1, exemplary tutorial system 100 includes medical apparatus 110, tutorial component 120, and user 130. Many types of medical apparatus 10 may also be used in the present invention, including but not limited to therapeutic mattresses such as low air loss mattresses, oxygen tanks, patient transfer lifts, or defibrillators, ventilators, suction drainage devices, or continuous positive airway pressure devices. Tutorial component 120 may be incorporated within medical apparatus 110 such that they form one physical unit. Alternatively, medical apparatus 110 and tutorial component 120 may be physically separate units. User 130 of the tutorial system 100, may be any person assisting the patient, such as trained medical personnel or non-medical caregivers, as well as the patient himself/herself.

Exemplary Tutorial Component

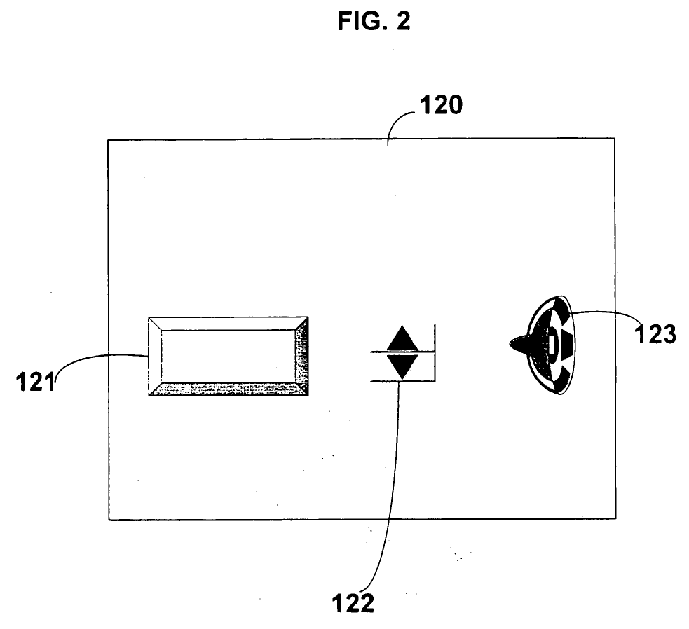

FIG. 2 is a simplified illustration of an exemplary embodiment of the external features of tutorial component 120. External features of exemplary tutorial component 120 include input instrument 121, control 122, and output instrument 123. Input instrument 121 is activated by user 130 to listen to, view, or otherwise receive instructions on the operation of medical apparatus 110. Input instrument 121 may be a button, a switch, an infra-red signal receiver, or a touch-sensitive screen. Other variations of input instruments known to those of skill in the art may alternatively be used. Output instrument 123 broadcasts the instructions to user 130. Output instrument 123 defines how the instructions are delivered to user 130, and may be, but is not limited to, a speaker or a screen. Finally, Control 122 adjusts the output of the instructions. It may be used to adjust the volume, speed, or another feature of a tutorial session.

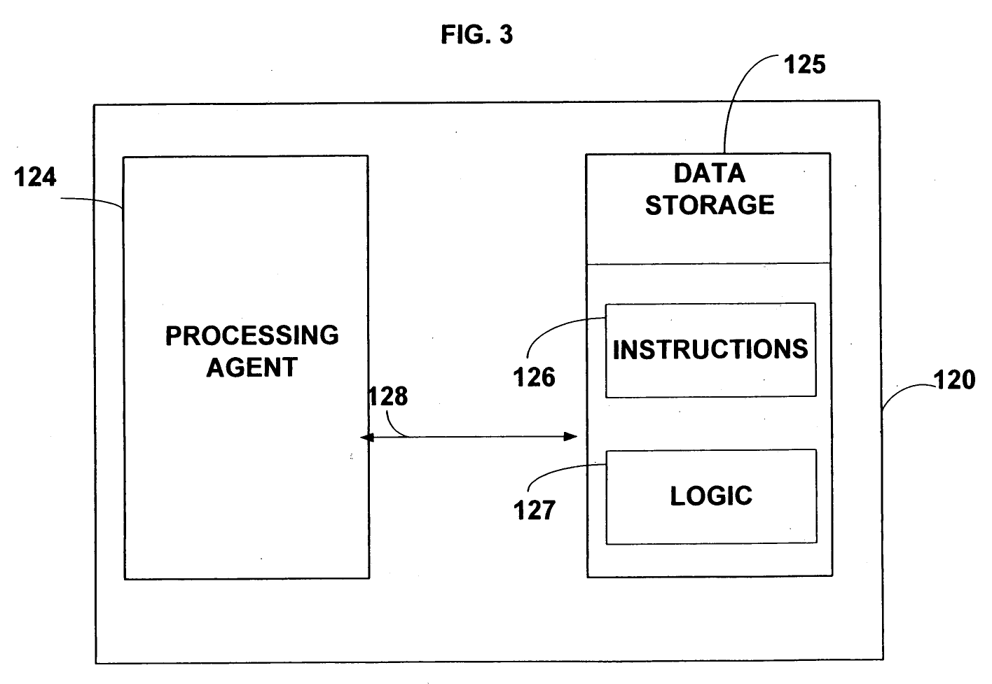

FIG. 3 is a simplified block diagram of the internal elements of tutorial component 120 suitable for carrying out exemplary embodiments of the present invention. Internally, tutorial component 120 includes at least processing agent 124 and data storage 125 interconnected via one or more busses shown collectively as a bus 128.

Processing agent 124 can be a microcontroller, an embedded processor, or another similar device. For example, in an embodiment where tutorial component 120 is incorporated within medical apparatus 110, the microcontroller used to operate medical apparatus 110 may also be used as processing agent 124 for tutorial component 120.

Data storage 125 stores instructions 126 for operating medical apparatus 110 and, preferably, also stores logic 127 to manage instructions 126. Instructions 126 may be stored in one or more of a variety of media types, such as a voice file or a video file.

Logic 127 causes instructions 126 to start playing at the beginning of an entire instructions file, or, if applicable, at the beginning of a segment of the instructions file, if the instructions are broken into segments. Logic 127 may be loaded into data storage 125 in the form of a software program, machine language instructions, or both, executable by processing agent 124. Alternatively, logic 127 may be stored in processing agent 124.

Exemplary Cycle of Operation of a Tutorial System

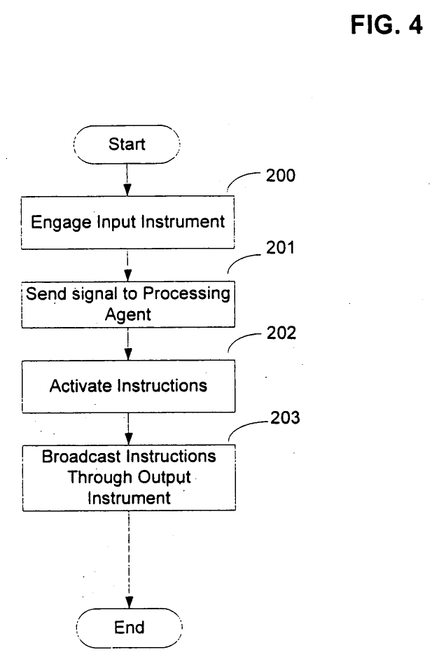

FIG. 4 is a flow chart depicting an embodiment of one cycle of operation of the tutorial system 100. At step 200, user 130 engages input instrument 121 of tutorial component 120. After input instrument 121 is activated, a signal is sent to processing agent 124, which in turn, activates instructions 126 stored in data storage 125, as shown at steps 201 and 202. Then at step 203, tutorial component 120 broadcasts instructions 126 on the operation of medical apparatus 110 to user 130 through output instrument 123.

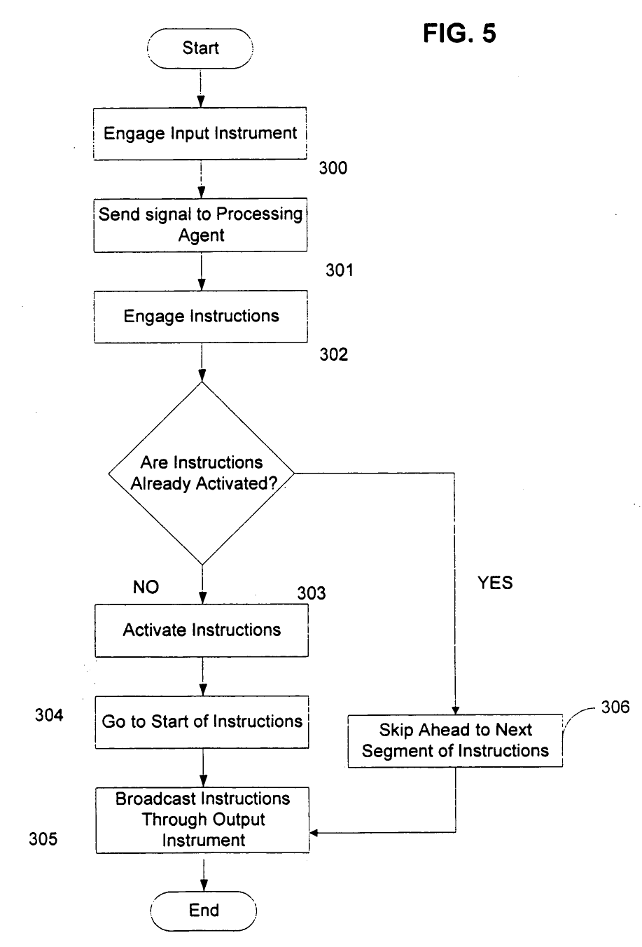

FIG. 5 illustrates an alternative cycle of operation of the tutorial system 100. In this embodiment, tutorial component 120 can be set up in a way that allows user 130 to skip between segments of instructions 126. Thus, in the same manner as described above with reference to FIG. 4, user 130 of the tutorial component 120 engages input instrument 121, as depicted at step 300. The activation of input instrument 121 causes a signal to be sent to processing agent 124, which in turn, engages instructions 126 stored in data storage 125, as shown at steps 301 and 302. If instructions 126 are already activated, then processing agent 124 causes instructions 126 to skip ahead to the next segment of instructions 126, as at step 306 and broadcasts the next segment of instructions 126 through output instrument 123, as depicted at step 205. On the other hand, if instructions 126 are not already activated, processing agent 124 activates the first segment of instructions 126, as shown at step 303, and broadcasts instructions 126 to user 130 through output instrument 123, as depicted at steps 204 and 205, respectively.

While exemplary embodiments have been described, persons of skill in the art will appreciate that variations may be made without departure from the scope and spirit of the invention. It should be understood that this and other arrangements described herein are set forth for purposes of example only. As such, those skilled in the art will appreciate that other arrangements and other elements can be used instead, and some elements may be omitted altogether. The true scope and spirit of the invention is defined by the appended claims, which may be interpreted in light of the foregoing.

1. A system for providing instantaneous tutoring to users of a medical apparatus on the operation of the medical apparatus, comprising in combination:
a medical apparatus; and
a tutorial component providing instructions on use and operation of the medical apparatus.

2. The system of claim 1, wherein the tutorial component is incorporated within the medical apparatus.

3. The system of claim 1, wherein the tutorial component is physically separate from the medical apparatus.

4. The system of claim 1, wherein the medical apparatus is a therapeutic mattress.

5. The system of claim 1, wherein the tutorial component further comprises an input instrument, a processing agent, instructions located within a data storage, and an output instrument, wherein the input instrument sends a signal to the processing agent that causes the processing agent to engage the instructions located within the data storage, and wherein the processing agent causes the instructions to be presented through the output instrument.

6. The system of claim 5, wherein the input instrument is selected from the group comprising a button, a switch, a receiver and a touch-sensitive screen.

7. The system of claim 5 wherein the processing agent is a microcontroller.

8. The system of claim 5 wherein the processing agent is an embedded processor.

9. The system of claim 5, wherein the data storage further comprises logic for managing the instructions stored within the data storage.

10. The system of claim 5, wherein the instructions stored in the data storage are broken into segments.

11. The system of claim 9 and 10, wherein the logic allows for skipping between segments of the instructions stored in the data storage.

12. The system of claim 5, wherein the output instrument is a speaker.

13. The system of claim 5, wherein the output instrument is a screen.

14. A system for providing instantaneous tutoring to users of a medical apparatus on the operation of the medical apparatus, comprising in combination:
a medical apparatus; and
a tutorial component in coordination with the medical apparatus, wherein the tutorial component is arranged to house an input instrument that sends a signal to a processing agent when the user of the medical apparatus activates the input instrument, the processing agent engages instructions located in a data storage, and an output instrument presents the instructions to the user of the medical apparatus.

15. The system of claim 14 wherein the medical apparatus is a therapeutic mattress.

16. The system of claim 14, wherein the input instrument is a button.

17. The system of claim 14, wherein the input instrument is a switch.

18. The system of claim 14, wherein the input instrument is a receiver.

19 The system of claim 14, wherein the input instrument is a touch-sensitive screen.

20. The system of claim 14, wherein the tutorial component is incorporated within the medical apparatus.

21. The system of claim 14, wherein the tutorial component is physically separate from the medical apparatus.

22. The system of claim 14 wherein the processing agent is a microcontroller.

23. The system of claim 14 wherein the processing agent is an embedded processor.

24. The system of claim 14, wherein the data storage further comprises logic for managing the instructions stored in the data storage.

25. The system of claim 14, wherein the instructions stored in the data storage are broken into segments.

26. The system of claims 24 and 25, wherein the logic allows for skipping between segments of the instructions stored in the data storage.

27. The system of claim 14, wherein the output instrument is a speaker.

28. The system of claim 27 further comprising a control for adjusting the broadcast of the instructions through the speaker.

29. The system of claim 14, wherein the output instrument is a screen.
